(19) United States
(12) Patent Application Publication
(10) Pub. No.: US 2010/0082955 A1
(43) Pub. Date: Apr. 1, 2010

(54) VERIFICATION OF CHIPSET FIRMWARE UPDATES

(76) Inventors: Jasmeet Chhabra, Hillsboro, OR (US); Mazen Gedeon, Hillsboro, OR (US); Sanjay Bakshi, Beaverton, OR (US); Eli Kupermann, Maale (IL)

Correspondence Address: Ryder, Lu, Mazzeo and Konieczny, LLC;C/O CPA Global, P. O. BOX 52050, MINNEAPOLIS, MN, 55402, US

(21) Appl. No.: 12/242,835

(22) Filed: Sep. 30, 2008

(51) Int. Cl. H04L 9/00; G06F 12/14; G06F 9/00

(52) U.S. Cl. 713/1; 726/27; 711/103; 711/E12.091

(57) ABSTRACT

In general, in one aspect, the disclosure describes an apparatus that includes updatable non-volatile memory to store firmware and non-updateable non-volatile memory to store an interrupt sequence. The apparatus includes a chip interface to receive an interrupt instruction from management firmware. Receipt of the interrupt instruction controls access to and initiation of the interrupt sequence. After initiation of the interrupt sequence the apparatus may receive a firmware update and/or validate the firmware is from a valid source. The validation of the firmware may include utilizing the management firmware to verify the cryptographic signature for the firmware.

### BACKGROUND

Computer systems utilize integrated circuits (ICs) to perform various functions (e.g., chipsets are utilized in order to free processing resources for the processor). The ICs may run firmware that defines the functions performed thereby. The ICs may receive updated firmware from time to time. The ICs may not validate or be capable of validating the firmware updates came from a valid (e.g., certified) source. The computer system may rely on an implicit trust that the firmware running on these ICs is valid. Given the threat of firmware rootkits being used to modify the firmware this trust is misplaced.

### BRIEF DESCRIPTION OF THE DRAWINGS

The features and advantages of the various embodiments will become apparent from the following detailed description in which:

FIG. 1A illustrates example communications between a management engine (ME) and an embedded controller (EC) for providing a public key for the EC firmware to the ME, according to one embodiment;

FIG. 1B illustrates a flow diagram of an example process for providing the public key from the EC firmware to the ME, according to one embodiment;

FIG. 2A illustrates example communications between the ME and EC firmware when the public key is burned into the ME during manufacturing, according to one embodiment;

FIG. 2B illustrates a flow diagram of an example process for burning the public key in the ME and the initial boot process, according to one embodiment;

FIG. 3 illustrates an example EC non-volatile memory configuration to be utilized for controlling firmware updates thereto, according to one embodiment;

FIG. 4 illustrates an example connection of the EC and the ME, according to one embodiment;

FIG. 5A illustrates example communications between devices to receive and verify an EC firmware update, according to one embodiment; and

FIG. 5B illustrates a flow diagram of an example process for receiving, applying and validating firmware updates, according to one embodiment.

### DETAILED DESCRIPTION

Computer systems may include a main processor (with one or more core), specific function processors (e.g., graphics processor) and other integrated circuits (ICs), such as chipsets and embedded controllers (ECs). The specific function processors and the ICs perform various functions in order to free processing resources for the main processor. The ICs may be limited to performing the functions defined in the firmware running thereon. The ICs may be capable of receiving and updating firmware running thereon but may not be capable of validating the firmware updates came from a valid (e.g., certified) source. A specific use processor may be capable of running management firmware thereon. The specific use processor may perform other functions besides the management functions (e.g., graphics processor) or may be a limited to management functions. The management firmware may provide various management functions, including but not limited to, secure communications, event tracking, error detection and correction, and reconfiguration. The management firmware may be a manageability engine (ME) such as that contained in Intel® chipsets with Active Management Technology. The management function is not limited to the ME, but it will be referred to herein as the ME for ease of discussion.

The ME interacts with the ICs and the firmware running thereon. The ME typically trusts that the firmware running on the ICs is valid even though the ICs may not validate or even be capable of validating the firmware updates. Accordingly, it is possible for one to maliciously modify the firmware running on the ICs. In order to validate the identity and integrity of firmware running on ICs (e.g., embedded controller (EC)), the firmware may be identified by a cryptographic signature that is generated based on the code and a public private key pair. A signature that is based on the code results in the signature of the firmware changing if the code is changed. A signature using a public private key pair means that any one with the public key may verify a signature but only those with the private key can generate a valid signature. If the firmware signature is verified, the identity and integrity of the firmware can be considered valid. However, if the signature is not verified the identity and integrity of the firmware may be considered invalid (e.g., the updates were provided by non-authorized entities). The ICs are not limited to an EC, but they will be referred to herein as the EC for ease of discussion.

The verification of the signature from the code and the public key requires some processing ability. According to one embodiment, the EC may store a public key therein and have the processing ability to verify the signature generated for the firmware based on the public key. The EC may also need the ability to determine and/or control the firmware updates and to initiate the verification process after the updates accordingly. Furthermore, in order to ensure that a hacker couldn't modify the public key at the same time they modified the code, the EC would need to have the ability to securely store the public key. It may not be practical to have the storage and/or processing ability on the EC (or other ICs).

According to one embodiment, the ME may be utilized to control the EC firmware updates and to verify the identity and integrity of the EC firmware by verifying the cryptographic signature for EC firmware using the public key. In order for the ME to verify the identity and integrity of the EC firmware, the ME needs to know the public key for the EC firmware. The public key may be stored in a configuration register within the ME that tracks various parameters about the configuration of the platform. The public key may be provided to the ME by the EC upon initial boot of the system or it may be burned into the ME during the manufacturing process.

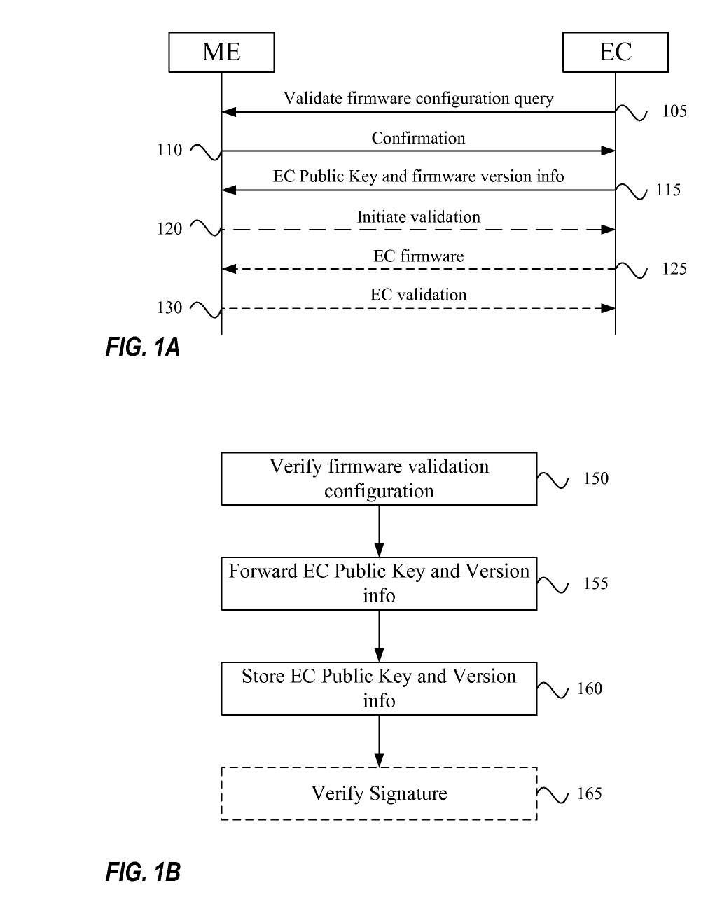

FIG. 1A illustrates an example communications between the ME and EC for providing the public key to the ME. The ME may provide a secure communication link (e.g., system management bus (SMBUS)) between the processor the ME is running on (e.g., virtual engine (VE)) and the EC. Upon initial platform boot up, the EC firmware determines if the ME is configured to validate firmware running on ICs within the platform 105. The determination may be in the form of a query sent over the SMBUS or may simply be a line status command sent over the SMBUS or a non-secure link. The ME confirms that it is configured to validate the firmware 110. The EC firmware then provides the ME with the EC firmware public key 115. It should be noted that after the initial platform boot when the ME stores the public key, the ME does not re-query the EC during subsequent boot cycles. The EC firmware may also provide the ME with the version information for the EC firmware. The version information may be used to determine when an update has been made (compare update version information to version information stored in ME).

After the ME stores the public key it may initiate a validation process 120. It should be noted that the process of providing the public key to the ME is predicated on the fact that the EC firmware installed in the factory is valid so that a verification of the signature would not be required. If the validation is initiated, the EC firmware may provide the firmware to the ME 125 so that the ME can utilize the public key to verify the signature. Upon successful verification of the signature, the ME may notify the EC firmware that the firmware was validated 130.

FIG. 1B illustrates a flow diagram of an example process for providing the public key from the EC firmware to the ME. Initially, the fact that the ME is configured to validate firmware needs to be verified 150. The public key and the firmware version number are then provided to the ME 155. The ME stores the public key and version information 160. The ME may then initiate a validation process 165. As noted above, the assumption is that the EC firmware installed in the factory is valid so that validation is not required at this point.

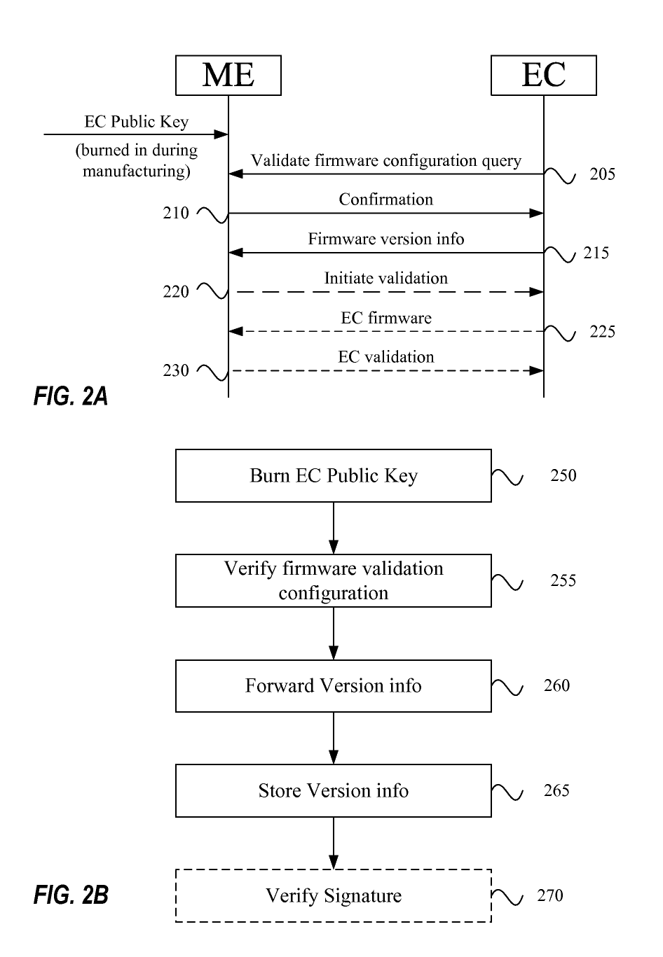

FIG. 2A illustrates an example communications between the ME and EC firmware when the public key is burned into the ME during manufacturing. For the public key to be burned in during manufacturing, the firmware provider for the EC and the public private key pair utilized by the provider for generating and verifying the cryptographic signature would need to be known. Upon initial platform boot up, the EC firmware determines if the ME is configured to validate firmware running on ICs within the platform 205. The ME confirms that it is configured to validate the firmware 210. The EC firmware then may provide the ME with the version information for the EC firmware 215. The version information may be used by the ME to determine when an update has been made to the EC firmware. The ME may then initiate a validation process 220. It should be noted that a verification of the signature may not be required at this point. If the validation is initiated, the EC firmware may provide the firmware to the ME 225 so that the ME can utilize the public key to verify the signature. Upon successful verification of the signature, the ME may notify the EC firmware that the firmware was validated 230.

FIG. 2B illustrates a flow diagram of an example process for burning the public key in the ME and the initial boot process. The public key is burned into the ME during the manufacturing process 250. During initial boot, the fact that the ME is configured to validate firmware needs to be verified 255. The firmware version number is then provided to the ME 265 and the ME stores the version number for later use 265. The ME may optionally initiate a validation process 270.

The ME may be utilized to control the EC firmware updates. The EC may receive firmware updates, or notification regarding the availability of firmware updates, but may wait to initiate the updates until instructed by the ME. The ME may also control the initiation of a validation sequence after an EC firmware update has been processed. If the validation (e.g., verification of the signature) is successful, the system may utilize the updated EC firmware. If the validation process is not successful, the system may reject the EC firmware update.

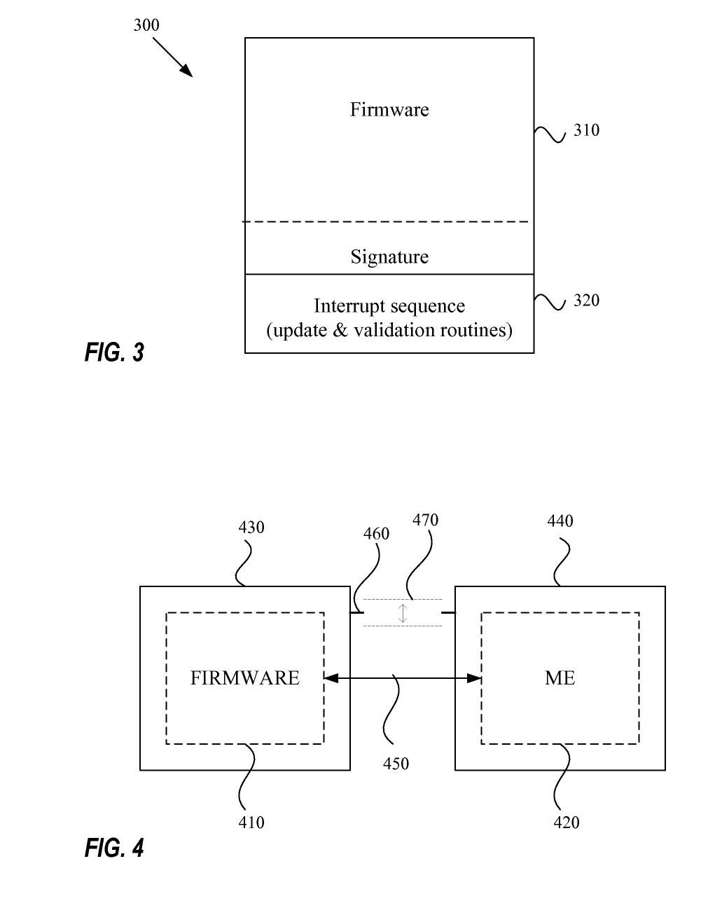

FIG. 3 illustrates an example EC non-volatile memory (e.g., flash) configuration to be utilized for controlling firmware updates thereto. The non-volatile memory 300 includes an updatable portion 310 and a non-updateable portion 320. The updateable portion 310 may include the firmware and the cryptographic signature generated based on the firmware and the private key. The non-updatable portion 320 (trusted portion) may include an interrupt sequence that interrupts the operation of the firmware. The trusted portion may also include an update sequence and a validation sequence or may enable an update sequence or validation sequence to be initiated. The update sequence may control the updating of the firmware in the updateable portion 310 and the validation sequence may initiate the verification of the signature (e.g., after an EC firmware update is complete). The interrupt sequence may be initiated by a boot or soft restart of the EC or may be initiated by the ME. The ME may control the initiation of a boot or restart of the EC. The ME may initiate the interrupt sequence by providing some input to the EC (e.g., pulling a signal high or low). The update or validation sequence may be run after initiation of the interrupt sequence and may be controlled by the ME (provide commands thereto).

FIG. 4 illustrates an example connection of the EC 410 and the ME 420. The EC 410 may be running on an IC 430 and the ME 420 may be running on one or more processors 440. The ME 420 and the EC 410 may communicate over a link 450 (e.g., secure link) between the IC 420 and one or more processors 440. The IC 430 may include a chip interface (e.g., pin, pad) 460 to receive an interrupt instruction (signal) 470 from the one or more processors 440. The receipt of the interrupt signal 470 may control access to the code stored in the un-updateable portion of the EC non-volatile memory (e.g., 320). The ME 440 may control the interrupt signal 470 that is provided to the chip interface 460. For example, if a high interrupt signal is provided (chip interface 460 is pulled high) a non-maskable interrupt sequence may be triggered (initiated) from the trusted portion of the non-volatile memory.

The interrupt sequence may interrupt the running of the firmware and may initiate the update sequence and/or the validation sequence. The update and validation sequences may automatically run after the interrupt or may be selected to run. The selection of the appropriate sequence to be run after the interrupt of the firmware may be controlled in any number of manners. For example, the EC firmware may wait for a command from the ME defining what to do next after the interrupt. The ME may provide commands defining what sequence to perform after the interrupt of the firmware is concluded. An appropriate sequence may be selected by the signal received on the chip interface 460 (e.g., a high signal may initiate the update sequence after the interrupt and a low signal may initiate the verification sequence or vice versa). The update sequence may be run after a first interrupt and the validation sequence may be run after a second interrupt. The validation sequence may be run only after an interrupt is received after the update sequence. The interrupt may run both sequences in order.

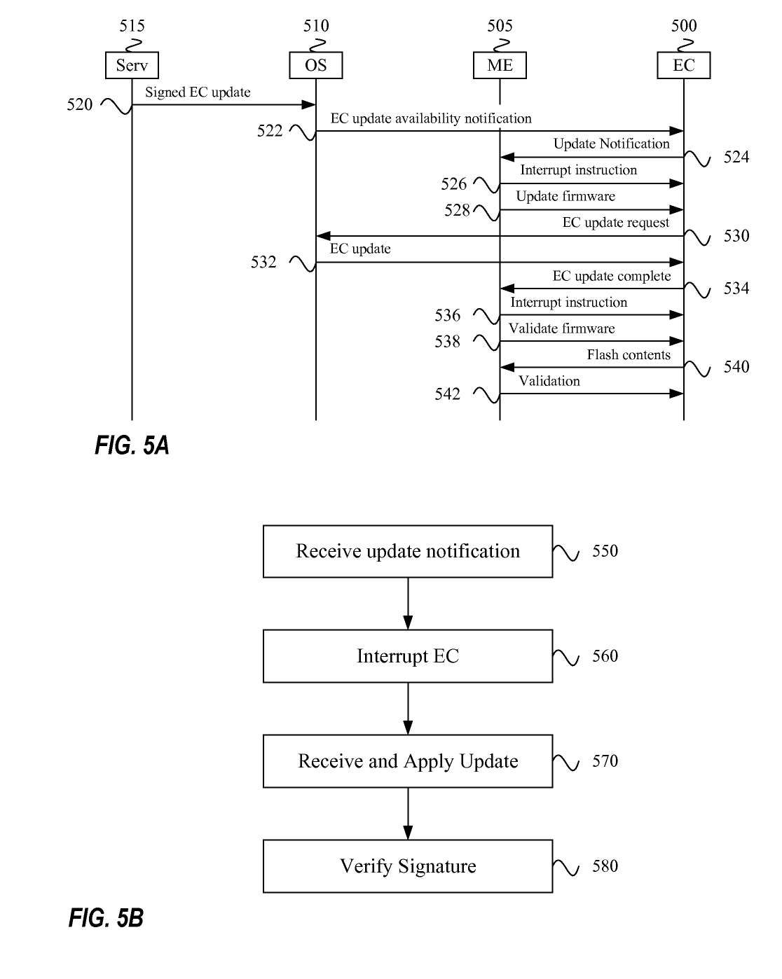

FIG. 5A illustrates example communications between devices to receive and verify an EC firmware update. An update server 515 notifies a host operating system (OS) 510 that a signed EC firmware update is available (520). The OS 510 sends an update notification (522) to the EC 500. The EC 500 sends an update notification (524) to the ME 505. The ME 505 provides an interrupt instruction (e.g., a high or a low signal) to the chip interface of the EC 500 (526) to initiate an interrupt of the EC firmware. The EC 500 interrupts the firmware and enters an interrupt mode. The ME 505 instructs the EC 500 to perform a firmware update (528) and the EC requests the firmware update from the OS 510 (530). The OS 510 sends the firmware updates to the EC 500 (532) and the EC 500 applies the updates. The EC 500 notifies the ME 505 when the update is complete (534). When the update is complete the EC 500 may exit the interrupt mode. The ME 505 provides an interrupt instruction to the chip interface of the EC 500 (536) to initiate another interrupt of the EC 500. The EC 500 interrupts the firmware and the ME 505 blocks the OS 510 from communicating with the EC 500 at this point. The ME 505 instructs the EC 500 to validate the firmware update (538) and the EC 500 forwards the contents of the flash (updated firmware or all firmware) to the ME 505. The ME 505 verifies the signature and notifies the EC 500 that the firmware was validated EC 500.

FIG. 5B illustrates a flow diagram of an example process for receiving, applying and validating firmware updates. Initially a firmware update notification is received by the EC and the EC notifies the ME 550. The ME provides the chip interface of the EC either a high or a low signal to initiate the interrupt 560. The EC then receives and applies the firmware update 570. After the update is complete the firmware is validated by verifying the cryptographic signature 580.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed:

1. An apparatus comprising
updatable non-volatile memory to store apparatus firmware;
non-updateable non-volatile memory to store an interrupt sequence; and
a chip interface to receive of an interrupt instruction, wherein the receipt of the interrupt instruction is to control access to the interrupt sequence.

2. The apparatus of claim 1, wherein the interrupt sequence is to run upon receipt of the interrupt instruction.

3. The apparatus of claim 2, wherein the interrupt instruction is to be received from a processor running management firmware.

4. The apparatus of claim 3, wherein the apparatus is to await further instruction from the management firmware after running the interrupt sequence.

5. The apparatus of claim 3, wherein the updatable non-volatile memory is to receive and store updated apparatus firmware after running the interrupt sequence.

6. The apparatus of claim 5, wherein the updatable non-volatile memory is to request validation of the updated apparatus firmware after the updated apparatus firmware is stored.

7. The apparatus of claim 6, wherein the updatable non-volatile memory is to transmit the updated apparatus firmware to the management firmware to verify a cryptographic signature for the updated apparatus firmware.

8. A method comprising
receiving an interrupt instruction from management firmware running on a processor, wherein the interrupt instruction is received on a chip interface;
running an interrupt sequence contained in a non-updateable portion of non-volatile memory, wherein the interrupt sequence interrupts operation of apparatus firmware running from an updateable portion of the non-volatile memory; and
receiving an additional instruction from the management firmware.

9. The method of claim 8, wherein the receiving an additional instruction includes initiating an update sequence to receive an apparatus firmware update.

10. The method of claim 9, wherein the initiating an update sequence includes receiving the apparatus firmware update from an operating system and storing the apparatus firmware update in the updateable portion of the non-volatile memory.

11. The method of claim 8, wherein the receiving an additional instruction includes initiating a validation sequence to validate the firmware update.

12. The method of claim 11, wherein the initiating a validation sequence includes
providing at least a portion of the apparatus firmware and a cryptographic signature for at least a portion of the apparatus firmware to the management firmware to verify the apparatus firmware cryptographic signature, and
receiving a verification status from the management firmware.

13. The method of claim 8, further comprising providing a public key to the management firmware, wherein the public key is used to verify a cryptographic signature for the firmware.

14. The method of claim 13, wherein the providing a public key includes providing the public key from the apparatus firmware upon initial platform boot.

15. The method of claim 8, wherein the receiving an interrupt instruction is in response to receiving notification that a firmware update is available.

16. A system comprising
a processor to run management firmware, wherein the management firmware includes a configuration register to store a public key of a public private key pair used to generate a cryptographic signature; and
at least one integrated circuit (IC) to run IC firmware, wherein the IC includes updatable non-volatile memory to store the IC firmware and a cryptographic signature for the IC firmware and non-updateable non-volatile memory to store an interrupt sequence, wherein the IC includes a chip interface to receive an interrupt instruction from the management firmware, wherein the receipt of the interrupt instruction is to control access to the interrupt sequence.

17. The system of claim 16, wherein the management firmware provides the interrupt instruction when IC firmware updates are available and instructs the IC to initiate an update sequence after the interrupt sequence is performed.

18. The system of claim 16, wherein the management firmware provides the interrupt instruction when IC firmware updates are complete and instructs the chipset to initiate a validation sequence after the interrupt sequence is performed.

19. The system of claim 16, wherein the public key is burned in the configuration register during manufacturing.

20. The system of claim 16, wherein the public key is provided to the management firmware during initial system boot up.
